(19) United States
(12) Patent Application Publication
(10) Pub. No.: US 2026/0223789 A1
(43) Pub. Date: Aug. 6, 2026

(54) MULTIFUNCTIONAL ENVIRONMENTAL GROUND COVER MATERIAL AND METHOD OF MANUFACTURE, SYSTEM FOR RECURSIVE ECOLOGICAL REGENERATION

(71) Applicant: Arsurus California LLC, Oceanside, CA (US)

(72) Inventors: JOHN MICHAEL BUETHE, IRVINE, CA (US); MARIA GNARRA BUETHE, IRVINE, CA (US)

(21) Appl. No.: 19/236,744

(22) Filed: Jun. 12, 2025

Related U.S. Application Data
(60) Provisional application No. 63/752,417, filed on Jan. 31, 2025.

(51) Int. Cl. A01G 13/35; A01G 24/12; A01G 24/22

(52) U.S. Cl. CPC A01G 13/35; A01G 24/12; A01G 24/22

(57) ABSTRACT

A multifunctional ground cover formula, ground cover material using the formula, and associated manufacturing methods are disclosed. The ground cover is engineered to perform a diverse set of environmental functions—including erosion control, carbon sequestration, vegetation restoration, stormwater management, fire resistance, and soil remediation. The formula is customizable and tunable, enabling precise adjustment of ingredient ratios to serve varied ecological or infrastructural applications. Certain ground cover formulas may further incorporate ecological memory substrates—biologically and culturally rooted materials—enabling recursive restoration of native land identity such as through embedded seed DNA, carbon memory, and biome-specific signal compounds. Embodiments are designed for scalable deployment, long-term biodegradation, and integration with native ecosystems.

This application claims the benefit of U.S. Provisional Pat. Appl. Ser. No. 63/752,417, filed on Jan. 31, 2025.

### BACKGROUND OF THE INVENTION

### Field of the Invention

The present invention relates to customizable, multifunctional ground cover formulas and methods for their use, designed to support a variety of environmental and infrastructural needs including erosion control, carbon sequestration, vegetation restoration, soil remediation, stormwater management, and fire resistance, and can include materials designed to remember and regenerate native ecological memory. The invention enables tailored applications for climate resilience, land rehabilitation, and ecological integration.

### Description of the Related Art

Traditional approaches to environmental ground management rely on a variety of disconnected products—such as hydroseeding mulches, fire retardant slurries, carbon sequestering soil amendments, and biodegradable erosion blankets. Each of these materials tends to serve a single purpose, often with limited adaptability to varying site-specific needs. As global environmental pressures increase—from soil erosion, biodiversity collapse, water scarcity, to intensified wildfires—there is a critical demand for integrated, multifunctional ground cover solutions that can be flexibly tuned to local conditions. This invention addresses that demand with a unified, composable material system capable of being applied in a wide variety of natural and man-made environments.

There has been more attention paid to ways to be more proactive in reducing wildfires and at least the spread of the wildfires, before they start. Some of these include efforts to clear brush around homes and businesses or including automatic type sprinklers that would activate when a fire is nearby.

The increased frequency of recent fires can at least partially be attributed to climate change. The increasing urgency of climate change has prompted the need for innovative solutions that address carbon emissions and provide carbon sequestration while promoting sustainability across various industries. The focus now is on reduction of harmful emissions and ways to sequester harmful emissions.

### SUMMARY OF THE INVENTION

The present invention is directed to a family of ground cover formulas and ground cover materials that can be flexibly customized to achieve a range of environmental goals. Depending on the desired application, different embodiments can emphasize erosion control, vegetation anchoring, carbon sequestration, stormwater absorption, fire resistance, and environmental remediation. This eliminates the need for multiple specialized products and offers both functional versatility and ecological compatibility.

Each embodiment according to the present invention can be tuned through compositional variation—for example, increasing the proportion of moisture-retentive or fibrous materials for slope stabilization, or emphasizing carbon-rich biochar and microbial inoculants for regenerative soil practices. Fire resistance is one of several performance dimensions, achieved through natural insulating minerals and moisture-buffering agents, but may not be the sole or primary application focus. The invention's strength lies in its customizable, multi-functional design, which supports large-scale landscape applications, urban green infrastructure, ecological restoration, and carbon-smart land use.

This ground cover can be partially dehydrated for lightweight shipping and rehydrated on-site, and can integrate native seed mixes, biogenic binders, soil conditioners, and natural fibers to meet site-specific requirements. Its broad adaptability makes it suitable for use in forestry, agriculture, construction zones, post-disaster recovery, and urban ecological projects, among many others.

In different embodiments, fire resistance can be provided by any natural mineral or nutrient having fire resistant characteristics that can be added to a fiber matrix applied and to the soil for the purposes of suppressing or resisting fire. These embodiments can be particularly applicable to suppressing or resisting the spread of wildfires.

The embodiments of the present invention can also comprise soil stabilization provided by different materials such as fibrous materials, clays, and binders that prevent erosion and stabilize soil while supporting long-term vegetation anchoring. Embodiments can also provide environmental remediation characteristics provided by materials such as biochar, zeolite, and can provide for fungal actively restoring soil health, while seeds (pre-germinated in some embodiments) ensure rapid vegetation establishment. Carbon sequestration can also be provided in different embodiments by providing one or more materials such as biochar, zeolite, vegetation from seeds, and microbial activity to lock carbon in the soil and support climate change mitigation.

The formula according to the present inventions can be affordable, eco-friendly, and adaptable to a wide range of uses. For example, the materials in the formula that provide fire resistance, soil stabilization, environmental restoration, and carbon sequestration, can be increased or decreased depending on the desired characteristics for the particular location. If fire sequestration is important the percentage of fire sequestration/suppression materials in the formula can be increased. If it is less important, the percentage of material can be decreased. The same applies to the materials of the other functions of soil stabilization, environmental restoration, and carbon sequestration. This allows for the formulas according to the present invention to be customizable to meet user needs.

Different embodiments of the present invention can comprise materials and functions beyond those described above. Some of these embodiments can incorporate different materials that provide different characteristics.

These and other aspects and advantages of the invention will become apparent from the following detailed description and the accompanying drawings which illustrate by way of example in the features of the invention.

### BRIEF DESCRIPTION OF THE DRAWINGS

FIG. 1 is a table showing embodiments of materials for embodiments of ground cover formulas according to the present invention;

FIG. 2 is a table showing an embodiment of materials for another embodiment of ground cover formula according to the present invention;

FIG. 3 is a flow-chart showing one embodiment of a production process of the ground cover formula according to the present invention; and

FIG. 4 is a flow-chart showing another embodiment of a production process of the ground cover formula according to the present invention.

### DETAILED DESCRIPTION OF THE INVENTION

The present invention relates to a novel ground cover formula and ground cover using the formula that can provide many different functions including, but not limited to wildfire mitigation, erosion control, invasive species suppression, carbon sequestration, stormwater management, agricultural soil enhancement, landscape and turf growth, and green roof growth thereby eliminating the need for multiple specialized products perform these function and providing a customizable product that can be formulated in different ways to provide functions particularly applicable to the desired functions. In some embodiments, the formula can be customized so that the desired one or two functions is more prominent than the other, thereby providing flexibility for different applications and locations.

Different embodiments of the formulas and ground cover according to the present invention can also comprise specialized compounds and later that can help restore or return the area into is natural or native states. The formula and ground cover can comprise symbolic memory materials that encode and reinforce ecological identity, including native seed blends, carbon-bound substrates, and biologically compatible fiber matrices. These can form a coherent biological layer, designed to operate as a unified system for site restoration—combining moisture regulation/retention, microbial activation, and regenerative anchoring into a single deployable surface. The formulas and ground cover can also be further customized to site-specific ecological memory, using different data points such as local soil data, climatic pressures, and biome identity to ensure the restoration is context-aware and recursive—restoring not just vegetation, but the native composition (or intelligence) of the land itself.

Certain ground cover formulas may further incorporate ecological memory substrates—biologically and culturally rooted materials—enabling recursive restoration of native land identity such as through embedded seed DNA, carbon memory, and biome-specific signal compounds. “The formula of claim 1, further comprising symbolic memory materials, selected to reflect the historical biome identity of the application site, wherein said materials include native seeds, carbon-stabilized biomass, and biologically active substrates configured to encode ecological memory.” wherein the functional elements are configured to operate in a recursive dependency, wherein moisture retention enhances seed germination, which enhances carbon sequestration, which enhances microbial health, which enhances fire resistance and erosion control. In some embodiments the ground cover can function as a unified living skin designed to regenerate ecological structure through multi-phase performance, including thermal buffering, hydrological modulation, biological restoration, and symbolic re-seeding.

Different embodiments can be arranged in many different ways to provide the advantages discussed above and can also provide additional advantages and inventive features. The formulas described herein can have many different compounds and materials beyond those described herein some of which perform the same function or differing functions to those described herein. It will also be understood that the different embodiments of fabrication methods according to the present invention can comprise additional or fewer steps and can comprise different steps that perform that same or different functions.

### Fire Resistance

Some embodiments of the improved ground cover formula and associated ground cover can provide increased fire-resistance that resists ignition during wildfires. This can help slow or prevent the spread of fire across the area having the ground cover and can extremely important in fire prone areas where the ground cover can slow or prevent spread of the wildfire to areas such as areas of homes or business structures.

Many different materials can be used to provide fire resistance in the ground covers and formulas according to the present invention including, but not limited to minerals such as one or more of gypsum, kaolin clay and perlite that can be embedded into the ground cover formula, creating a multi-layered defense against the spread of wildfires by suppressing flames and providing thermal insulation. Gypsum releases water vapor under heat, suppressing flames and cool the ground cover material. Kaolin clay forms a heat-resistant barrier, preventing ignition of the ground cover material. Kaolin clay acts as a natural fire suppressant, is heat resistant and can form a protective barrier on the surface of the soil that prevents oxygen from feeding the fire. When kaolin clay is exposed to heat, it can help insulate underlying materials, thereby reducing the spread of flames. Perlite can provide thermal insulation, further reducing heat transfer. These are only some of the fire suppressant or resistant materials and compounds that can be included in the different embodiments of the present invention.

### Carbon Sequestration and Ground Stabilization

The improved ground cover formula according to the present invention also can comprise different seeds and in some embodiments these seeds can be pre-germinated. Embodiments of the present inventions can include common plant seeds that can be embedded within ground cover during manufacturing. Some embodiments of the present invention utilize seeds for native plants such as California grasses and California poppy. In some embodiments the seeds can be switchgrass (Panicum virgatum) seeds, but it is understood that other plant seeds can be used. Switchgrass is a native perennial grass known for its rapid growth and ability to sequester carbon through photosynthesis. Including plant seeds can facilitate post-consumer carbon capture through planting. When the ground cover is applied to the desired location, the embedded seeds germinate and grow, sequestering carbon as they photosynthesize and establish root systems. The present invention can incorporate any plant seed in weight-density of greater than 200,000 seeds per pound to achieve targeted levels of carbon sequestration in the finished ground cover product.

In other embodiments, the seeds in the ground cover formula can comprise pre-germinated native seeds, primed through controlled hydration and nutrients. Providing pre-germinated seeds can accelerate vegetation establishment, reducing germination time and ensuring faster rooting to stabilize the soil faster. This pre-germination also enhances the formula's effectiveness in erosion control, especially on slopes and in high-risk areas. This also supports pollinator biodiversity and long-term ecosystem restoration.

Different embodiments of the ground cover formula and ground cover can be partially dehydrated during manufacturing, with the formula being rehydrated at the location where ground cover is to be applied. In some embodiments, the formula can be partially dehydrated (0-15% residual moisture) which reduces transport and storage costs and results in application flexibility. Partial dehydration can also extend shelf life by reducing microbial activity and preventing degradation of biodegradable components during storage. The reduction in transport and storage costs can be the result of lighter weight and reduced volume. This can lower costs and reduce carbon emissions during transport.

The dehydrated ground cover can then be rehydrated by the user, such as on-site of application, to the desired hydration level. This results in the formula being customizable to the desired rehydration level. On-site rehydration allows users to adjust consistency for application methods (e.g., hydroseeding slurry or thicker paste for targeted areas). Certain components and elements such bentonite clay, mycelium spores, and biochar rehydrate effectively, ensuring full functionality upon rehydration and application.

Beyond the embedded seeds discussed above different formulas according to the present invention can also include components and elements that provide for carbon sequestration characteristics. The cellulose fiber matrix can be infused with carbon sequestration materials or compounds which enhance the paper's ability to adsorb CO2 while providing structural integrity. Biochar can be included that can lock atmospheric carbon in the ground cover and soil for decades. In addition to its carbon sequestration characteristics, biochar can also provide additional fire resistance. Biochar is carbonized, which results in it not being easily ignited. Biochar can also absorb heat and reduce the amount of combustible material available to the fire.

In some embodiments, the carbon sequestration material can comprise other materials like zeolite, calcium carbonate or a combination thereof, but it is understood that other carbon sequestration materials can be used either alone or in combination.

Zeolite is a naturally occurring aluminosilicate mineral characterized by its porous structure and ability to adsorb carbon dioxide (CO2), which makes it an effective agent for capturing atmospheric carbon. Zeolite is characterized by its large surface area and in the presence of water it can mineralize CO2. Zeolite can be found in nature, and is particularly well-suited to enhancing soil conditions and carbon sequestration because it adsorbs CO2 and water (both critical for plant growth) and can sequester carbon continuously.

Calcium carbonate can also be included and can be derived from sources such as limestone. It further enhances the paper's carbon sequestration capabilities through its ability to chemically react with CO2, converting it into stable calcium carbonate compounds. Embodiments of the present invention can include calcium carbonate for enhancement, but it is understood that other embodiment can also be provided without calcium carbonate, and can instead rely on the carbon sequestration properties of zeolite or similar materials.

Beyond carbon sequestration, these materials can provide the additional advantage of improving the physical properties of the different embodiments of the present invention, such as strength and durability. Zeolite and calcium carbonate can also take on properties of cement when used in our application of the ground cover. Zeolite's crystalline structure gives the ground cover depth and strength and an ability to better absorb liquids and gases. Calcium carbonate ties the ground cover together like cement, enhancing bulk and making it easier to use in standard applications.

This dual functionality of carbon sequestration materials and plant seeds not only promotes sustainability in ground cover production but also contributes to environmental restoration efforts by encouraging carbon sequestration through both the paper's intrinsic properties and the growth of vegetation. The invention offers a practical but powerful solution for reducing carbon footprints and creating significant functional value.

Mycelium spores amplify microbial activity, improving carbon cycling and retention. mycelium that supports organic matter enrichment. Mycelium can also be included which acts as a natural binder that enhances structural integrity of the different embodiments. This material also promotes soil health and microbial activity as it decomposes. It also provides the advantage of aiding in moisture retention, fire resistance, and environmental remediation, thereby contributing to eco-friendly and regenerative properties.

The embodiments according to the present invention also provide for enhanced soil stabilization under the ground cover. Many different materials can be used for this stabilization including bentonite clay which as swelling properties that enhance soil cohesion, particularly in sandy or porous soils. Fibrous materials (e.g. wastepaper, DLK) and binders (e.g. guar gum, corn starch) help prevent erosion and improve adhesion to uneven terrain. The native plants in the seed mix anchor the soil for long-term stabilization.

Embodiments of the present invention also provide sustainability and scalability. The formulas according to the present invention can comprise recycled materials (wastepaper, DLK), natural minerals, and biodegradable binders. The formulas are cost-effective and environmentally friendly. The formulas also provide for local sourcing of components like gypsum, clays, and biochar ensures scalability for large projects.

### Composition of One Embodiment of Ground Cover Formula

Different embodiments of ground cover formula according to the present invention can comprise many different materials, compounds and seeds, with the following being one embodiment of the materials in different ranges different and one illustrative embodiment.

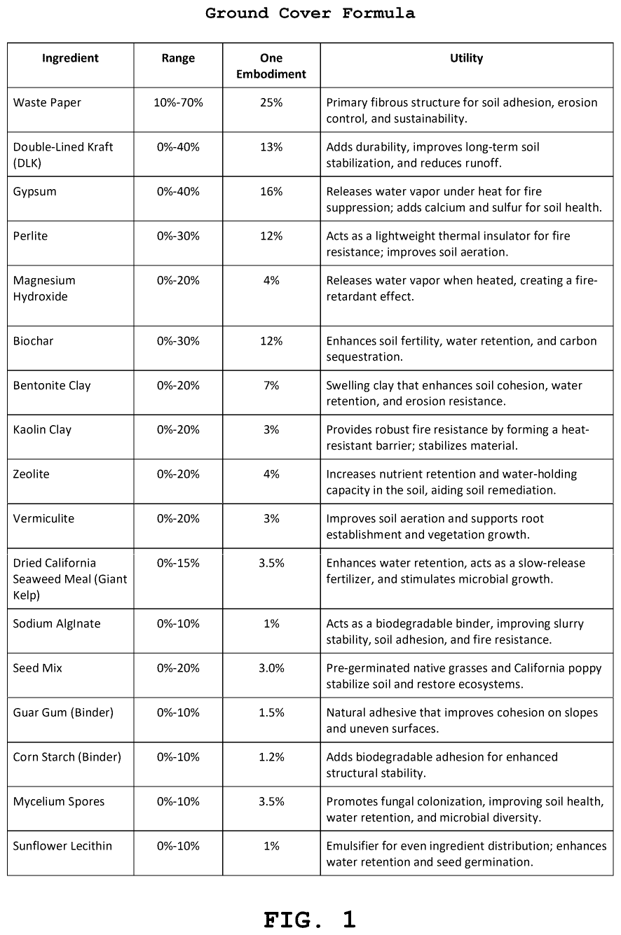

Referring now to FIG. 1, a primary component of the ground cover formula is recycled post-consumer wastepaper, which can comprise between 10% to 70% of the total composition. In some embodiments this component can comprise waste office paper (white ledger) and can comprise the percentage of total composition outlined above, or can comprise percent compositions such as between 0% and 65% or 0% to 40%. These ingredients can provide the primary fibrous structure and backbone, ensuring soil adhesion, structural cohesion and stabilization. Use of recycled wastepaper or white ledger not only reduces the demand for virgin wood fibers but also diverts waste from landfills, thereby minimizing the environmental footprint of the formula. The wastepaper also provides the fibrous structure for erosion control and sustainability. These materials can also reduce fire intensity by retaining moisture and can prevents soil erosion through strong adhesion. The formula can also be biodegradable, and can contribute to organic soil restoration. In one embodiment, the recycled wastepaper can comprise approximately 25% of the ground cover formula but it is understood that other embodiments can comprise more or less recycled wastepaper.

To enhance the strength and durability embodiments of the present invention, the formulas can comprise natural fibers from different sources. In some embodiments the formula can comprise natural fibers sourced from cotton or hemp. These fibers are known for their high tensile strength and ability to retain moisture, which is critical for supporting the growth of the embedded seeds.

Double-lined kraft (DLK) can also be included in the ground cover formulas according to the present invention in a percentage range of 0% to 40% or 0% to 65% in other embodiments. DLK can also provide for the fibrous backbone for soil adhesion and structural cohesion. This component also can add durability, improve long-term soil stabilization, reinforce erosion resistance, improve soil stability on slopes, and can reduce runoff. DLK can also enhances soil structure for long-term stabilization, thereby reducing wind and water erosion in high-risk areas. DLK can also provide fire resistance and thermal protection. In one embodiment, the ground cover formula can comprise 13% DLK, but it is understood that other embodiments can comprise more or less DLK.

The formula according to the present invention can also comprise recycled post-consumer wastepaper (PCW) in different percentages, such as in the range of 0% to 65&. PCW can also provide many advantages such as providing soil adhesion and structural cohesion.

Gypsum can be included in the formulas according to the present invention as described above, and can be in a percentage range of 0% to 40%. Gypsum can provide the properties described above and can act to release water vapor under heat for fire suppression, cooling surfaces and suppressing flames. It adds calcium and pH to the formula for soil health where it is applied, thereby aiding in plant growth. In one embodiment, the ground cover formula can comprise 16% gypsum, but it is understood that other embodiments can comprise more or less gypsum.

Perlite can also be included in the formulas according to the present invention, and can be included in a percentage range of 0% to 30%. Perlite can provide the properties described above and can act as a lightweight thermal insulator for fire resistance, thereby reducing heat transfer while improving soil aeration. Perlite slows fire spread by disrupting heat conduction. It also prevents soil compaction and enhances root penetration. In one embodiment, the wastepaper formula can comprise 12% perlite, but it is understood that other embodiments can comprise more or less perlite.

Pumice (either crushed or powered) can also be included that can be used in combination with or as a substitute for Perlite. Pumice can be included in different percentages of the formula such as in the range of 0% to 20%. Pumice can have the advantage of being locally sourced and can aid in water retention and thermal insulation.

Magnesium Hydroxide can be included in the formulas according to the present invention, and can be included in a percentage range of 0% to 20%. Magnesium Hydroxide releases water vapor when heated, creating a fire-retardant effect. It enhances fire suppression while maintaining being eco-friendly. It also balances soil pH where applied, which can improve plant nutrient intake. In one embodiment, the ground cover formula can comprise 4% magnesium hydroxide, but it is understood that other embodiments can comprise more or less magnesium hydroxide.

Biochar can be included in the formulas according to the present invention, and can be included in a percentage range of 0% to 30%. Biochar can provide the functions and advantages discussed above and can enhance soil fertility, water retention, long term carbon sequestration by storing organic carbon. It can also support microbial activity for faster soil regeneration. In one embodiment, the ground cover formula can comprise 12% biochar, but it is understood that other embodiments can comprise more or less biochar.

Bentonite clay can be included in the formulas according to the present invention as described above, and can be included in a percentage range of 0% to 20%. Bentonite clay can provide the functions and advantages discussed above and provides a swelling clay that expands upon moisture absorption. This can enhance soil cohesion and adhesion by binding loose particles, and promotes water retention and erosion resistance. Bentonite clay is particularly applicable to drought-prone areas. In one embodiment, the ground cover formula can comprise 7% bentonite clay, but it is understood that other embodiments can comprise more or less bentonite clay.

Kaolin clay can be included in the formulas according to the present invention, and can be included in a percentage range of 0% to 20%. Kaolin clay can provide the functions and advantages discussed above and forms a compact, heat-resistant layer, that reinforces fire protection and soil adhesion. Kaolin clay provides the further advantage of being a stabilizing material that adheres to resist soil erosion. In one embodiment, the ground cover formula can comprise 3% kaolin clay, but it is understood that other embodiments can comprise more or less kaolin clay.

Zeolite is discussed above and can be included in the formulas according to the present invention. It can be included in a percentage range of 0% to 20%. Zeolite can provide the functions and advantages discussed above and provides improved soil nutrient retention and water holding capacity. It traps nutrients and moisture, preventing nutrient leaching in poor soils. It improves soil health by storing and slowly releasing minerals, which enhances microbial habitat and supports long-term restoration. Zeolite also enhances the paper's ability to adsorb CO2 due to its porous structure and also contributes to the formula's durability and moisture retention. This can be essential for supporting embedded seeds included in the formula. It also aids and promotes soil remediation. In one embodiment, the ground cover formula can comprise 4% Zeolite, but it is understood that other embodiments can comprise more or less Zeolite.

Vermiculite can be included in the formulas according to the present invention, and can be included in a percentage range of 0% to 20%. Vermiculite can provide the functions and advantages discussed above and provides improved soil moisture retention and aeration. It also supports root establishment, root expansion, root growth, and seeding survival. In one embodiment, the wastepaper formula can comprise 3% Vermiculite, but it is understood that other embodiments can comprise more or less vermiculite.

Seeds or seeds mixes (“seeds”) are discussed above and these can be included in the formulas according to the present invention. Seeds can be included in a percentage range of 0% to 20%. Seeds provide the advantages discussed above and can comprise native plant seeds. For example, in California the seeds can comprise native grasses and California poppies, both of which provide rapid vegetation provide biodiversity, and stabilize the soil when grown to restore native ecosystems. The seeds also strengthen the soil structure by root stabilization. In one embodiment, the wastepaper formula can comprise 3% seeds, but it is understood that other embodiments can comprise more or less seeds.

Dried seaweed (e.g. California giant kelp, sugar kelp or sargassium) can be included in the formulas according to the present invention, and can be included in a percentage range of 0% to 10%. Dried seaweed can enhance ecosystem restoration, water retention, act as a slow release fertilizer, increase carbon sequestration, and can stimulate microbial growth. Dried seaweed contains high levels of potassium, calcium, and trace minerals. It improves soil microbial activity and biodiversity, and contributes organic carbon to aid in soil fertility. The characteristics make seaweed desirable for both wildfire and erosion control. Utilizing locally sourced, renewable seaweed, reducing reliance on imported binders. Seaweed retains moisture, reduces flammability, and creates flame-resistant ash. In one embodiment, the ground cover formula can comprise 3.5% dried seaweed, but it is understood that other embodiments can comprise more or less.

Sodium alginate can be included in the formulas according to the present invention, and can be included in a percentage range of 0% to 10%. Sodium alginate can act as a biodegradable binder, thereby improving slurry stability, soil adhesion, and fire resistance. It binds soils together, helps create a shear-thinning slurry for better hydroseeding applications, and provides environment remediation and restoration. It can also enhance fire resistance through gel-like moisture retention. In one embodiment, the ground cover formula can comprise 1% sodium alginate, but it is understood that other embodiments can comprise more or less.

Guar gum can be included in the formulas according to the present invention, and can be included in a percentage range of 0% to 10%. Guar gum can provide a natural cohesion by acting as an adhesive that improves soil adhesion, and is particularly applicable to soil cohesion to prevent material runoff on slopes or uneven surfaces. It can also improve erosion resistance in high-impact areas. In one embodiment, the ground cover formula can comprise 1.5% guar gum, but it is understood that other embodiments can comprise more or less guar gum.

Corn starch can be included in the formulas according to the present invention, and can be included in a percentage range of 0% to 10%. Corn starch provides biodegradable adhesion that is eco-friendly, improves structural integrity and can protect the embedded seeds. The corn starch acts as a binding agent, helping to hold the fibers together while ensuring that the seeds remain viable. It enhances seed adhesion to soil surfaces for better germination rates. In one embodiment, the ground cover formula can comprise 1.2% corn starch, but it is understood that other embodiments can comprise more or less.

Xantham gum and also be included as a substitute for or in combination with corn starch and can be included in different percentages of the formula such as in the range of 0% to 10%. Xantham gum can also work as a binding and thickening agent for the formula.

Mycelium spores can be included in the formulas according to the present invention, and can be included in a percentage range of 0% to 10%. Mycelium spores can promote fungal colonization, thereby improving soil health, water retention and microbial diversity. It improves nutrient exchange between soil and plants and accelerates ecosystem recover in degraded soils. In one embodiment, the ground cover formula can comprise 3.5% mycelium spores, but it is understood that other embodiments can comprise more or less mycelium spores.

Sunflower lecithin can be included in the formulas according to the present invention, and can be included in a percentage range of 0% to 10%. Sunflower lecithin functions as an emulsifier for even distribution and prevents separation in storage and application. It also enhances water retention for fire resistance and seed germination, and optimizes soil stability. In one embodiment, the wastepaper formula can comprise 1% sunflower lecithin, but it is understood that other embodiments can comprise more or less sunflower lecithin.

Hydrogels can also be included in the formulas according to the present invention, such a environmentally friendly hydrogels. These can be included in different percentage ranges in the formulas according to the present invention, such as in the range of 0% to 10%. Hydrogels can provide advantages such as absorbing and retaining large amounts of water. In some embodiments the hydrogels can be environmentally friendly and can comprise a biodegradable polymer network.

### Alternative Ingredients

It is understood that the formulas according to the present invention cam comprise the components above in different combinations and concentrations. It is also understood that different formulas can comprise other components, materials and elements in different concentration and combinations depending on the desired functional characteristics of the formula. Some of the alternatives are as follows with exemplary concentration ranges. It is understood that other similar elements or combination of elements can be used in the same or different concentration ranges.

Chitosan can be included in a concentration range of 0% to 40%. Chitosan is a biodegradable polymer derived from chitin (found in crustacean shells), chitosan offers excellent binding and antimicrobial properties. It could further enhance the structural integrity and durability of the matrix.

Tannin Extracts can be included in a concentration range of 0-40%. Tannin is sourced from oak or chestnut bark, and tannins naturally char when heated, providing additional flame-retardant benefits without relying on synthetic chemicals.

Lignin Derivatives can be included in a concentration range of 0% to 40%. Lignin derivatives are derived from plant biomass, lignin can be modified to improve char formation and thermal insulation, enhancing the fire resistance of the product while remaining fully biobased.

Humic Substances (Humic or Fulvic Acid) can be included in the range of 0% to 20% These natural soil conditioners can boost nutrient retention and microbial activity, supporting environmental remediation and overall soil health when incorporated into the formulation.

Nanocellulose or microfibrillated Cellulose can included in a concentration range of 0% to 20%. These act as a reinforcement agent, and these forms of cellulose can improve the water retention and mechanical strength of the mix. Their high surface area and natural origin make them an attractive option for enhancing the fiber matrix.

Natural enzyme consortia can be included in a concentration range of 0% to 20%. Natural Enzyme Consortia This element comprises a blend of microbial enzymes that can accelerate organic matter decomposition, aiding in faster nutrient cycling and soil remediation. These can be sourced from compost accelerators or organic agriculture suppliers.

Recycled cardboard can be included in a concentration range of 0% to 40%. Cardboard can be pulped to provide a robust, fibrous backbone. Recycled cardboard is also widely available and can enhance structural cohesion when processed to a consistent size.

Newspaper and newsprint can be included in a concentration range of 0% to 40%. These are often available in large quantities and recycled newspaper can serve as an excellent fiber source. It can comprise fine and uniform fibers that can be efficiently blended into the formula mix. In some instances, pre-treatment of newspaper and newsprint may be needed to adjust for differences in fiber length.

Agricultural residues can be included in a concentration range of 0% to 40%. These can comprise fibers from corn stover, rice husks, wheat straw, or sugarcane bagasse that offer sustainable, locally sourced alternatives. These residues are typically abundant and can be processed into a pulp form that contributes to soil binding and erosion control.

Reclaimed wood fiber can be included in a concentration range of 0% to 40%. These can take the form of sawdust or wood chips from recycled lumber or wood processing waste and can be included to provide additional strength to the formula matrix. In some instances, they may need to be finely milled, but their natural durability and availability can make them a desirable option.

Textile waste can be included in a concentration range of 0% to 40%. These can comprise post-consumer textile fibers (e.g., from cotton or other natural fibers). These may also be incorporated in the formula matrix to improve tensile strength. In some instances, careful pretreatment of textile waste may be needed to remove contaminants.

Additional and alternative ingredients that can be used include seaweed extract for growth stimulation, nutrient supplementation (0% to 8%). Sodium alginate or Xanthan Gum can be included for binding or stabilization (0% to 5%). Lignin derivatives can be used for char formation and insulation (0% to 40%). Nanocellulose, Microfibrillated Cellulose can be included for Mechanical reinforcement and water retention (0% to 20%). Allelopathic Plant Extracts (Mustard Seed, Garlic): can be included for invasive species suppression (0% to 5%). Activated charcoal can be included for filtration, and contaminant adsorption (0% to 10%). Mineral wool can be included for thermal insulation and moisture retention (0% to 10%). Hydrated lime (Calcium Hydroxide) can be included for pH regulation and pathogen control (0% to 10%). Dolomite lime can be included for soil pH balance and nutrient supply (0% to 10%). Potassium silicate can be included for plant resilience and cell wall strengthening (0% to 5%).

### Composition of a Second Embodiment of Ground Cover Formula

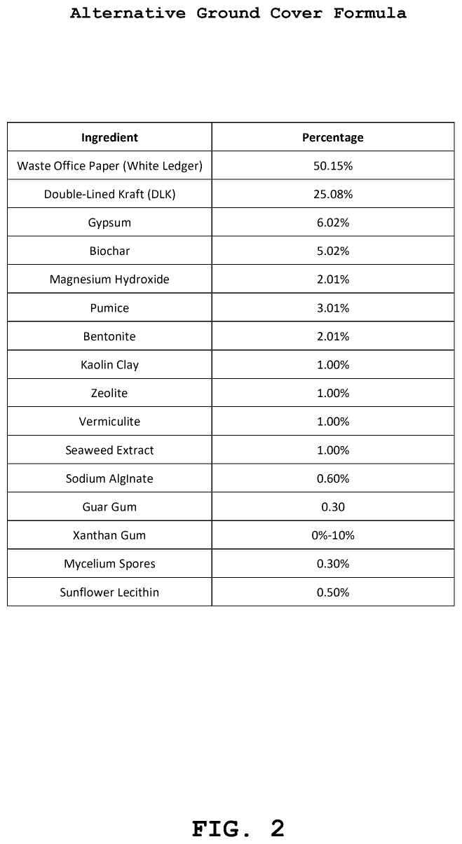

As mentioned above, different embodiments of ground cover formula according to the present invention can comprise many different materials, compounds and seeds, depending on the desired characteristics of the ground cover. Referring now to FIG. 2, is another embodiment of a ground cover formula according to the present invention, comprising a multi-functional fiber-based matrix designed for fire resistance, erosion control, vegetation establishment, and soil stabilization. It is understood that the percentages listed for the different ingredients is only one example of the percentages that can be included in different formulas according to the present invention.

### Potential Variants and Applications

The functional elements, components and ingredients above can be combined with different ones, and can be combined in different concentrations, to provide the desired ground cover characteristics.

In wildfire mitigation variants higher concentrations of gypsum, magnesium hydroxide, biochar can be included for maximum fire resistance.

In erosion control variants higher concentrations of bentonite, vermiculite, fibers can be included for slope stabilization.

In green roof variants higher concentrations of vermiculite, biochar, lightweight minerals can be included for rooftop applications.

In invasive species suppression variants higher concentrations of native seeds, allelopathic plant extracts, competitive mycelium strains can be included.

In carbon sequestration variants higher concentrations of biochar, zeolite, mycelium can be included for enhanced carbon retention.

Landscape and turf variants can comprise optimized seed and fiber composition for rapid germination.

Stormwater management variants can comprise higher concentrations of zeolite, vermiculite, biochar for water retention and filtration.

Agricultural soil enhancement variants can comprise higher percentages of biochar, gypsum, seaweed extract for improved soil fertility.

Still other formulas and applications according to the present invention can realized using different combinations of the functional elements, components or ingredients listed above. One embodiment can comprise a soil moisture retention and drought buffering formula and application that can utilize many of the different ingredients above such as those wildfire mitigation and stormwater management variants described above, but can also use other ingredients. This embodiment can be used in rainwater catchment zones, urban tree wells and green infrastructure and perimeter zones for reforestation, as well as for climate-adaptive agriculture layering.

Another embodiment according to the present invention can comprise a heavy metal and toxin mitigation formula and application that can be used in many different applications. In one embodiment it can be used to mitigate lead, such as for remediation in urban gardens, playgrounds, and low-income housing. It can also be used for arsenic and cadmium mitigation such as in industrial brownfield management. This formula can be applied for different purposes such as PFAS/chemical spill buffer zones (if absorbency layer is enhanced) and as a landfill perimeter sealant.

Another embodiment according to the present invention can comprise seedbed and germination platform formulas and applications. These embodiments can be used for native seed deployment systems, controlled biodiversity reintroduction, seed paper integration for ceremonial planting, and habitat corridors for pollinators

Other embodiments according to the present invention can comprise enhanced carbon sequestration formulas for climate applications. These can comprise biochar-enhanced formulations for a long-term soil carbon sink, or a carbon lock in fire prone forest floors. These can also be used for Ag-field border sequestration layers or as post-disaster carbon-capture restoration layers or mats.

Other embodiments according to the present invention can comprise perimeter design and memory layering formulas and applications, such as for cemetery or ceremonial site stabilizers, or sacred land restoration layers that can be blended with symbolic flora. Other embodiments can comprise border markers that slowly degrade into memory-rooted vegetation.

Embodiments according to the present invention can comprise construction and industrial formulas and applications. These can be used for temporary ecological scaffolding for solar fields or pipelines, or soil shielding during trenching operations. These can also be used for sound berm layering with ecological restoration function or biodegradable construction erosion blankets.

Other embodiments according to the present invention can comprise formulas and applications for urban and public space use. These can include dust suppression in low-income zones, tree root protection in sidewalk cutouts or temporary ecological barriers during construction.

Still other embodiments of formulas and applications according to the present invention can comprise flood and waterflow modulation, such as for berms to guide floodwater. These can also be used for swale stabilization, canal edge preservation, or micro-watershed redirection.

It is understood that many other elements and compounds can be included in different embodiments according to the present invention. For example, in some embodiments, calcium carbonate can also be included in the composition at a concentration of 0-10%. This mineral can aid in carbon sequestration by chemically reacting with CO2.

As mentioned above, other embodiments can comprise symbolic memory materials that can not only serve the functional roles described herein (e.g. fire resistance, erosion control, seed germination, etc.), but also have materials and compounds to encode and reinforce biological or ecological identity of a particular area over time. These can comprises natural materials (e.g. native seeds, local fibers, carbon-stabilized biomass) that reflect the past composition (or memory) of a specific ecosystem. This can be what previously grew in a particular area, what belongs in that area, and how the land heals. These materials go beyond the functional characteristics above and signal what should return to the area. The “materials” themselves remember the ecosystem's past and are designed to encourage its return.

Other embodiments can comprise coherent biological layers that can integrated living layers that work together to repair, stabilize, and restore ecological function—instead of acting as isolated features and functions. These embodiments are more than mulch, seeds, soil amendments, or any of the compounds above, but comprises a single biologically-coordinated layer (or skin) that retains moisture, invites native fungi and microbes, buffers fire, and regenerates growth as a unified system. Coherence in this embodiment refers to the compounds and materials in the layer working together, structurally and biologically, to regenerate native life.

For the embodiments described herein, the formulas and ground covers can have a site-specific ecological formula (or “memory”}. Each deployed ground cover can be tailored to respond to the unique conditions of the particular area—such as local climate stress, native seed DNA, soil microbiome, fire history, or land use pattern—and is engineered to respond accordingly. For example, a formula deployed in Northern California may not be identical to one deployed in Arizona. Each embodiment can be embedded with biological memory specific to that ecosystem's needs—like adapted seed blends, fire-adaptive stabilizers, or moisture retention tuned to local rainfall and other weather patterns. Each the embodiments can be context-aware and can provide a healing cover (or skin} that responds to particular conditions and how to restore the area.

### First Production Process Embodiment

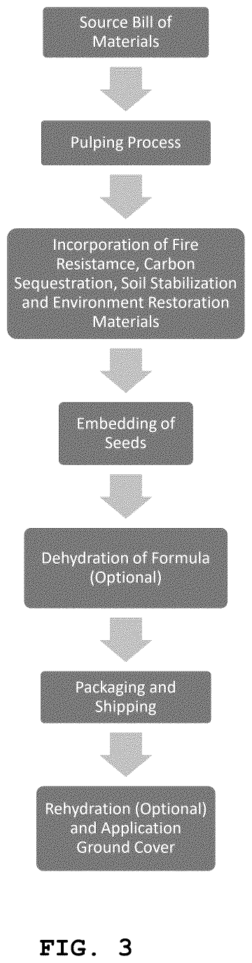

FIG. 3 shows one embodiment of a production process 100 according to the present invention that can be used to produce the formulas and matrixes described herein. The production of this ground cover formula can involve several steps designed to ensure the desired characteristics and optimal integration of materials.

In the first step 102 The bill of materials can be sourced from different providers, such as sustainable and local providers, and can be delivered to the manufacturing facility via standard freight.

The second step 104 can comprise a pulping process wherein the prepared recycled paper and natural fibers are mixed and blended with water to create a pulp. During this stage, the corn starch can be added to enhance the binding properties of the mixture. The pulp is thoroughly blended to ensure uniform distribution of all components.

The third step 106 can comprise incorporation of materials for the desired characteristics such as fire resistance, carbon sequestration materials, soil stabilization and environmental restoration. For example, zeolite powders can be added and blended with the pulp mixture, ensuring that it is evenly dispersed throughout. In some embodiments calcium carbonate powder can also be included and evenly dispersed through the matrix. This step is crucial for maximizing the carbon sequestration capabilities of the final product. During this step, many of the other materials and compounds discussed above can also be incorporated.

The fourth step 108 can comprise carefully embedding the seeds into the mixture a way to minimize damage to the seeds. This can be done by folding the seeds into the formula mixture to ensure they are evenly distributed while maintaining their viability.

In the fifth step 110 the ground cover formula can optionally be partially dehydrated during manufacturing, with the formula being rehydrated at the location where ground cover is to be applied. In the sixth step 112, the formula can be packaged and shipped.

In some embodiments, the formula can be partially dehydrated, which improves transport and storage costs and results in application flexibility. Partial dehydration can also extend shelf life by reducing microbial activity and preventing degradation of biodegradable components during storage. The reduction in transport and storage costs can be the result of lighter weight and reduced volume. This lowers costs and reduces carbon emissions during transport.

The dehydrated ground cover can then be rehydrated in the seventh step 114 by the user, such as on-site of application, to the desired hydration level. This results in the formula being customizable to the desired rehydration level.

### Second Production Process Embodiment

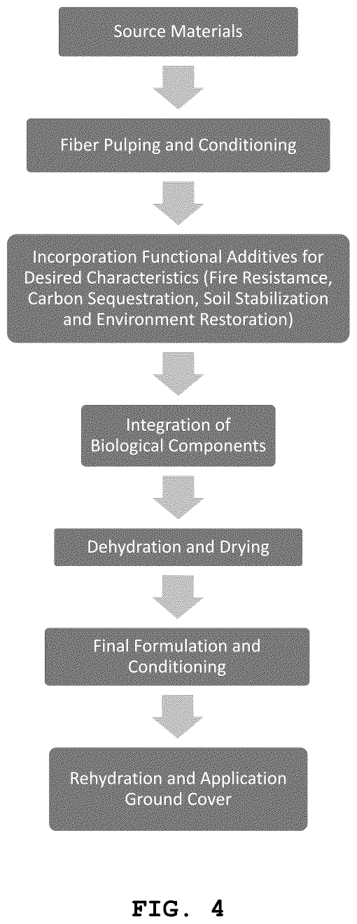

FIG. 4 shows a second embodiment of a production process 200 according to present invention for producing the formulations and matrixes described above.

In a first step 202 raw material can be prepared which can include different processes such as sourcing and blending recycled cellulosic fibers (e.g., post-consumer paper waste such as ledger, kraft, cardboard, etc.) with selected organic and mineral-based additives. The additives may include, but are not limited to mineral additives (e.g., gypsum, magnesium hydroxide, bentonite clay, kaolin clay, pumice, vermiculite, zeolite), organic additives (e.g., biochar, seaweed-derived compounds, fungal/mycelium inoculants), or binder additives (e.g., xanthan gum, guar gum, sodium alginate, lecithin-based emulsifiers)

In the second step 204 can comprise fibrous material pulping and conditioning, which can include processing of recycled fibers through mechanical and/or chemical pulping techniques to form a homogeneous slurry. This step can also include adjustment of slurry consistency and viscosity by adding water, binders, and rheological modifiers to achieve optimal material properties (e.g., viscosity typically ranging between approximately 2,000-10,000 centipoise).

In the third step 206, functional additives can be incorporated which can include uniform blending of mineral additives, bioactive ingredients, functional binders, soil remediation agents, or fire retardants into the fiber slurry. This step can also comprise processes to ensure thorough dispersion such as through mechanical agitation, high-shear mixing, or equivalent industrial blending techniques to achieve a homogeneous composition.

The fourth step 208 can comprise an optional integration of biological components. This step can include the selective addition of biological agents such as mycelium spores, microbial inoculants, or beneficial organisms, and includes ensuring their viability through careful management of moisture content, temperature, and mixing shear rates.

The fifth step 210 can comprise a dehydration and drying process to reduce moisture content of the final slurry. This step can comprise controlled dehydration methods such as rotary drum drying/dehydration, airflow-assisted dehydration, vacuum-assisted dehydration, or belt drying systems. This step can be used to target a final moisture content typically ranging from about 5% to 20%, in some embodiments the percentage can be around 10%-15%, to maximize stability, shelf-life, and rehydration performance.

The sixth step 212 can comprise the final formulation and conditioning, which can comprise processing dried product into convenient forms for transport, storage, or application such as by granulation, pelletizing, extrusion, briquetting, shredding, or flaking. This step can optionally comprise incorporating coating agents, stabilizers, or moisture-resistant barriers to enhance shelf-life and application properties.

The seventh step 214 can comprise rehydration and application methodology such as by hydrating final dried material with water. This hydration can typically be at ratios ranging from approximately 5:1 to 30:1 (water-to-material by weight), with suitable operational ratios being around 10:1 to 20:1. The hydrated slurry can then be applied as desired using standard industry equipment, including hydroseeders, sprayers, pumps, spreaders, or other suitable distribution devices.

The resulting formula or matrix product, when applied and dried, can provide multifunctional environmental performance characteristics. These can include, but are not limited to, enhanced erosion control and soil stabilization, fire resistance through mineral and moisture-based fire-retardant properties, carbon sequestration and soil fertility enhancement via biochar and/or organic amendments, environmental remediation through incorporated biological agents and soil conditioners, and rapid establishment of vegetation or microbial ecosystems when optionally combined with seeds or biological inoculants

### Additional Production Methods

The present invention is also directed to other production methods for different formulas or matrixes according to the present invention. One embodiment comprises a simple mulch production process to provide minimally moistened formula or matrix. This process can comprise a pulping stage to pulp DLK and/or Recycled Paper. Different pulping equipment can be used (such as a low-speed industrial pulper or blender) to break down the DLK and recycled paper into a consistent pulp. This helps ensure that the fibers are uniformly sized for better soil adhesion.

This process can then comprise dry blending to combine the pulped fibers with all other dry ingredients (clays, binders, seeds, etc.) in their specified proportions.

This process can then comprise minimal moistening by adding a limited amount of water or pre-moistened binders to lightly agglomerate the mix into a loose mulch. This can be done using low-speed mixers or manual mixing. The resulting product is a simple, dry-to-slightly-wet mulch that can be spread by hand or with simple mechanical spreaders.

Another production process according to the present invention can comprise an intermediate wet mulch process(non-homogenized). Like above, this process and include a pulping stage such as to pulp DLK and Recycled Paper in a dedicated pulping unit to achieve a consistent fiber pulp. This step is critical to ensuring an even distribution of fibers in the subsequent wet mix. This process can also include dry mixing to accurately blend the pulped fibers with all other dry ingredients, including clays, binders (e.g., guar gum, sodium alginate), and additives.

This process can then use controlled wetting or hydration, such as by gradually adding water to achieve a water-to-material ratio of range 1:1 to 15:1, creating a wet mulch. Low to moderate mixing can then be utilized such as through low-or moderate-speed mixers that lightly combine the ingredients. This produces a wet mulch that may not be fully homogenized but has sufficient consistency for application using conventional spreaders or low-pressure equipment. The resulting product can be applied broadly over an area, providing moisture retention and seed distribution without the need for a fully uniform slurry.

A third process according to the present invention can comprise a production of a Complex Homogenized Slurry for hydroseeder use. This process also includes a pulping stage to pulp DLK and Recycled Paper using pulping methods to finely process DLK and recycled paper into a very uniform, fine fiber pulp. This ensures maximum consistency and integration in the final slurry. Like above, this process can also comprise precise dry mixing to thoroughly blend the finely pulped fibers with all dry components, including clays, binders (guar gum, sodium alginate, xanthan gum), and other additives.

This process can then utilize controlled rehydration to gradually add water to the dry mix. In some embodiment the desired amount of water comprises a 5-15:1 water-to-material ratio. The water can be added while carefully monitoring the viscosity. This process can also comprise high shear mixing, such as by high shear mixers, to fully homogenize the slurry, to provide a uniform, pumpable product with a target viscosity of approximately 100-200 cP. This level of homogenization is desirable in some embodiments for the slurry to flow smoothly through a hydroseeder.

The present invention is described herein with reference to certain embodiments, but it is understood that the invention can be embodied in many different forms and should not be construed as limited to the embodiments set forth herein. It is further understood that different embodiments can comprise different materials or features arranged in different ways beyond those described herein. In particular, the ground cover formulas and compositions described herein are only some embodiments according to the present invention and other embodiments can have different concentrations of minerals, compounds or materials, and can comprise different minerals, compounds or materials.

Although the present invention has been described in detail with reference to certain embodiments, other versions are possible. Therefore, the spirit and scope of the invention should not be limited to the versions described above.

We claim:

1. A ground cover formula, comprising:
a primary fibrous structure for soil adhesion;
water to provide the desired hydration; and
two or more functional elements or components in a percentage range of 0% to 40% to provide the desired functional characteristics.

2. The formula of claim 1, wherein said desired functional characteristics are from the group comprising, wildfire mitigation, erosion control, invasive species suppression, carbon sequestration, stormwater management, agricultural soil enhancement, landscape and turf growth, and green roof growth.

3. The formula of claim 1, wherein said functional elements are configured to operate in a recursive dependency and provides for moisture retention, seed germination, carbon sequestration, microbial health and erosion control, wherein said moisture retention enhances said seed germination, which in turn enhances said carbon sequestration, which in turn enhances said microbial health, which in in turn enhances said fire resistance and said erosion control.

4. The formula of claim 1, wherein said fibrous structure comprises wastepaper, white ledger or double-lined kraft (DLK).

5. The formula of claim 2, wherein said wildfire mitigation functional elements comprise gypsum, magnesium hydroxide, or biochar.

6. The formula of claim 2, wherein said erosion control functional elements comprise bentonite, vermiculite or fibers.

7. The formula of claim 2, wherein said green roof growth functional elements comprise vermiculite, biochar and lightweight minerals.

8. The formula of claim 2, wherein said invasive species suppression functional elements comprise native seeds, allelopathic plant extracts and competitive mycelium strains.

9. The formula of claim 2, wherein said carbon sequestration functional elements comprise zeolite, mycelium and seeds.

10. The formula of claim 2, wherein said landscape and turf growth functional elements comprise optimized seeds and fiber.

11. The formula of claim 2, wherein said stormwater management functional elements comprise zeolite, vermiculite, and biochar.

12. The formula of claim 2, wherein said agricultural soil enhancement functional elements comprise biochar, gypsum, and seaweed extract.

13. The formula of claim 1, further comprising symbolic memory materials that reflect the historical biome identity of the site where said formula is applied.

14. The formula of claim 13, wherein said symbolic memory materials can comprise native seeds, carbon-stabilized biomass, or biologically active substrates configured to encode ecological memory.

15. The formula of claim 1, wherein said ground cover functions as a unified living skin comprising functional elements to regenerate an ecological structure through multi-phase performance, including thermal buffering, hydrological modulation, biological restoration, and symbolic re-seeding.

16. A method for manufacturing a ground cover, comprising:
sourcing and preparing the formula ingredients including fibrous material, water and functional ingredients;
pulping, conditioning and hydration of said fibrous material;
incorporation said functional ingredients in an amount to meet the desired functional characteristics of said ground cover;
dehydration to the desired hydration level; and
final formulation for storage or transport.

17. The method of claim 16, wherein said pulping can comprise adding water, binders, or rheological modifiers to achieve the desired properties.

18. The method of claim 16, wherein said incorporating of functional additive comprises ensuring thorough dispersion such as through mechanical agitation, high-shear mixing, or equivalent industrial blending.

19. The method of claim 16, wherein said dehydration comprises rotary drum drying/dehydration, airflow-assisted dehydration, vacuum-assisted dehydration, or belt drying systems.

20. The method of claim 16, wherein said final formulation comprises granulation, pelletizing, extrusion, briquetting, shredding, or flaking.

21. The method of claim 16, further comprises rehydration of said ground cover.

22. The method of claim 16, wherein said functional characteristics comprise wildfire mitigation, erosion control, invasive species suppression, carbon sequestration, stormwater management, agricultural soil enhancement, landscape and turf growth, and green roof growth.

23. The method of claim 22, wherein said wildfire mitigation ingredients comprise gypsum, magnesium hydroxide, or biochar.

24. The method of claim 22, wherein said erosion control ingredients comprise bentonite, vermiculite or fibers.

25. The method of claim 22, wherein said green roof growth ingredients comprise vermiculite, biochar and lightweight minerals.

26. The method of claim 22, wherein said invasive species suppression ingredients comprise native seeds, allelopathic plant extracts or competitive mycelium strains.

27. The method of claim 22, wherein said carbon sequestration ingredients comprise zeolite, mycelium or seeds.

28. The method of claim 22, wherein said landscape and turf growth ingredients comprise optimized seeds or fiber.

29. The method of claim 22, wherein said stormwater management ingredients comprise zeolite, vermiculite, and biochar.

30. The method of claim 22, wherein said agricultural soil enhancement ingredients comprise biochar, gypsum, or seaweed extract.
